(19) United States
(12) Patent Application Publication
(10) Pub. No.: US 2024/0403599 A1
(43) Pub. Date: Dec. 5, 2024

(54) HEALTH STATE ASSESSMENT METHOD FOR EQUIPMENT BASED ON KNOWLEDGE GRAPH ATTENTION NETWORK

(71) Applicant: ZHEJIANG UNIVERSITY OF TECHNOLOGY, Zhejiang (CN)

(72) Inventors: Gang Xiao, Zhejiang (CN); Jiacheng Huang, Zhejiang (CN); Yuanming Zhang, Zhejiang (CN); Zhenbo Cheng, Zhejiang (CN); Xuesong Xu, Zhejiang (CN); Jiawei Lu, Zhejiang (CN); Qibing Wang, Zhejiang (CN)

(73) Assignee: ZHEJIANG UNIVERSITY OF TECHNOLOGY, Zhejiang (CN)

(21) Appl. No.: 18/475,200

(22) Filed: Sep. 26, 2023

(30) Foreign Application Priority Data
May 31, 2023 (CN) 202310630743.6

(51) Int. Cl. G06N 3/042; G06N 3/048; G06N 3/08

(52) U.S. Cl. CPC G06N 3/042; G06N 3/048; G06N 3/08

(57) ABSTRACT

Disclosed in the present invention is a health state assessment method for equipment based on a knowledge graph attention network, includes: steps: 1) constructing a graph data model which can comprehensively reflect change of a health state of the equipment by deeply integrating association relationships of equipment components, monitoring data dependence relationships and priori information, etc. by means of a knowledge graph and by combining with domain priori knowledge; 2) extracting feature information of the health state knowledge graph by using a graph attention network, and obtaining a target node vector representation which accurately reflects the health state of the equipment by means of learning; and 3) making a health state representation vector of the equipment pass through a fully connected layer to obtain a health state classification prediction probability, and performing training to reducing a loss value relative to a true label, thereby obtaining a health state assessment result.

### CROSS-REFERENCE TO RELATED APPLICATION

This application claims the priority benefit of China application serial no. 202310630743.6, filed on May 31, 2023. The entirety of the above-mentioned patent application is hereby incorporated by reference herein and made a part of this specification.

### TECHNICAL FIELD

The present invention relates to the technical field of knowledge graphs, graph neural networks and health state assessments, and in particular to a health state assessment method for equipment based on a knowledge graph attention network.

### BACKGROUND

A health state assessment is an important basis of maintenance strategy formulation and maintenance resource management of equipment, and is the premise of predictive maintenance, fault prediction and health management. As a degree of integration and informatization of an equipment system keeps being improved, working reliability of complex equipment is of great importance, and it is significant to evaluate a health state thereof.

Health state assessment methods are mainly divided into three categories, namely model-driven methods, knowledge-driven methods and data-driven methods.

The model-driven method is based on a failure mechanism or working mechanism of components, a corresponding physical model is established, and then a physical model-driven health state assessment is performed. In IEEE Transactions on Reliability, 2015, Hanachi, etc. took a heat loss index and a power loss index as two feature indexes to construct a health state assessment model based on a physical model, which is used for a health state assessment of gas turbine engines.

In Aerospace Science and Technology, 2016, Lu, etc. proposed a nonlinear underdetermined state estimation method based on an extended Kalman filter, which is used for a health state assessment of gas turbine engines.

In Reliability Engineering & System Safety, 2017, Rabiei, etc. proposed a recursive Bayesian fusion method based on an empirical crack growth model, periodic crack size measurement and online crack growth rate estimation, which is used for a health state assessment of mechanical structures. The model-driven method has the advantages of low time-space complexity and clear physical meaning, but the model-driven method has high requirements on integrity and accuracy of a mathematical analytical model to be constructed.

The knowledge-driven method is based on expert knowledge, and a mapping relationship between degradation features and a health state is established by means of reasoning analysis. In Acta Energiae Solaris Sinica, 2018, Hu Yaogang, etc. established a wind turbine generator health state assessment model based on evidence reasoning according to the idea of evidence source correction. In IEEE Transactions on Dielectrics and Electrical Insulation, 2018, Arshad, etc. evaluated a health state of a transformer oil-paper insulation system by using fuzzy logic reasoning. In Microelectronics Reliability, 2018, Yin, etc. evaluated a health state of a turbofan engine gas path fan by using a confidence rule base optimized based on an adaptive covariance matrix evolution strategy. In the knowledge-driven method, horizontal and vertical degradation processes of the whole machine or a subsystem can be modeled based on domain expert knowledge, and the method has the advantages of low time-space complexity and clear physical meaning. However, incomplete, one-sided and fuzzy priori knowledge will reduce accuracy of a health state assessment model, and a knowledge-based static health state model also fails to represent a dynamic degradation process of electromechanical equipment.

In the data-driven method, based on component state monitoring data and health state parameters, a health state assessment is performed. In Neurocomputing, 2018, Guo, etc. recognized a health state of bearings by using a convolutional neural network, where network parameters were learned by using an error back propagation algorithm and an adaptive matrix estimation algorithm.

Mathematical Problems in Engineering, 2018, Sun, etc. recognized a health state of a wind turbine generator by using a long-short-term memory network, and network parameters were learned by using an error back propagation algorithm. In Sensors, 2019, Xu, etc. combined a convolutional neural network and a random forest to achieve a health state assessment of rolling bearings. The data-driven method needs a large amount of state monitoring data and has the advantages of no need of expert knowledge and high accuracy. However, a health state assessment model based on the data-driven method lacks clear physical explanation and is likely to be disturbed by noise and abnormal samples.

To sum up, the existing equipment health assessment methods have not achieved fusion of data from different sources, and fusion of spatial features and temporal features in the data, so there are relatively large limitations. It is an important method to use a graph neural network to evaluate a health state of equipment based on fusion of a knowledge graph and spatio-temporal data of the equipment.

### SUMMARY OF THE DISCLOSURE

In order to fuse spatial domain correlation features with temporal domain change features, the present invention provides a health state assessment method for equipment based on a knowledge graph attention network. A graph data model which may comprehensively reflect change of a health state of the equipment is constructed by deeply integrating association relationships of equipment components, monitoring data dependence relationships and priori information by means of a knowledge graph. Based on the constructed health state knowledge graph of the equipment, feature information of the health state knowledge graph is extracted by using a graph attention network, and a vector representation which accurately reflects the health state of the equipment is obtained by means of learning. A health state assessment problem is transformed into a node classification problem based on the vector representation, and the health state assessment of the equipment is achieved.

The technical solutions of the present invention are as follows:

A health state assessment method for equipment based on a knowledge graph attention network includes following steps:

### 1) Constructing a Health State Knowledge Graph of the Equipment

### 1.1) Extracting Component Entities and Relationships

As the equipment is usually composed of a system which is composed of a lot of components, separately extracting the component entities and relationships according to a composition relationship between the system and the components, where each non-divisible component represents a component entity, the component relationships include an energy transfer relationship, a structure composition relationship and a control relationship, etc., and granularity of component entities may be adjusted according to assessment requirements, where the component entities refer to component states of components at a certain moment, and the component relationships refer to the relationships between the component states, for example, the state of component A may affect the state of component B.

### 1.2) Extracting Monitoring Index Entities and Relationships

As sensor monitoring data is mostly class one of time series data, which reflects variability features of the health state of equipment, extracting the monitoring index entities and the monitoring relationship (monitoring relationship refers to the relationship between monitoring indexes, for example, index C and index D simultaneously monitor the state of component A) with the component entities from time series data, and performing normalization processing; and
for each piece of monitored time series data {xₜ_{₁}, xₜ_{₂}, xₜ_{₃}, . . . , xₜ_{ₙ}}, performing division by using a time sliding window technique, setting a window size as b, and aggregating a monitored value set of each window, where a common aggregation method is to find an average value, that is, if xₜ_{_{y}}∈[xₜ_{₁},xₜ_{₁}+b),

$${x}_{{t}_{y}} = \frac{1}{k} {\sum }_{i = 1}^{k} {x}_{{t}_{i}} \} ;$$

due to different dimensions of the monitored data, normalizing different monitoring data, and a calculation formula being as follows:

$${x}_{n o r m}^{i} = \frac{{x}^{i} - {x}_{m e a n}^{i}}{{\partial }^{i}} \qquad ( 1 )$$

where xₙₒᵣₘⁱ represents a normalized value of the i^{th} sensor, xⁱ represents data collected by the i^{th} sensor, and xₘₑₐₙⁱ and ∂ⁱ represent a mean value and a variance of an original measurement value of the i^{th} sensor respectively.

### 1.3) Constructing the Knowledge Graph

Constructing the health state knowledge graph of the equipment according to the extracted component entities, component relationships, monitoring index entities and monitoring relationships, where component nodes represent health states of components at a certain moment, and a formal definition is as follows:
the health state knowledge graph of the equipment is a directed graph which is composed of the component entities and the relationships thereof, includes the component entities, the monitoring index entities, the component relationships and the monitoring relationships, has time labels, and is expressed as G=(E, R, T, τ), where E is an entity set, which includes the component entities and the monitoring index entities, R is a relationship set with time stamps, which includes component state relationships and the monitoring relationships, τ represents a current time stamp of the knowledge graph, T={(h, r, t)|h, t∈E, r∈R} is a set of triples, and
the constructed health state knowledge graph with the time labels is capable of expressing the relationship between a health state of the equipment at each moment and a monitoring index.

### 2) Performing Representation Learning of the Knowledge Graph Based on the Graph Attention Network

Embedding the health state knowledge graph into a unified vector representation space by using a graph attention network model to obtain vector representations of the entities and relationships, and using a vector representation of a target entity for a health state assessment task of the equipment.

### 2.1) Achieving Input and Output of the Graph Attention Network

Defining a node feature of input of the graph attention network as h={h₁, h₂, . . . , h_{N}}, hᵢ∈R^{F}, where N is the number of nodes, F is a dimension of the node feature, an output new feature vector is F′ after passing through the graph attention network, and an output feature vector is represented as h′={h₁′, h₂′, . . . , h_{N}′}, hᵢ′∈R^{F′}.

### 2.2) Calculating an Attention Coefficient of a Central Node

In order to obtain sufficient expression ability, converting an input feature into a higher-level vector representation; calculating attention coefficients between the central node and neighbor nodes thereof one by one, where a calculation formula is as follows:

$${e}_{i j} = a ( [ {W}_{e} {h}_{i} ‖ {W}_{e} {h}_{j} ] ) \qquad ( 2 )$$

where Wₑ∈R^{F′×F} is a shared weight matrix, linear transformation of the nodes is expressed as Wₑhᵢ∈R^{F′}, the features after the linear transformation of the nodes are spliced by using the method of ⋅∥⋅, that is, Wₑhᵢ∥Wₑhⱼ∈R^{2F′}, a(⋅) is a single-layer feedforward neural network with a parameter of \vec{a}∈R^{2F′}, and the spliced high-dimensional features is mapped to the real number R by using the method of a(⋅), thereby obtaining the attention coefficient of the central node relative to each neighbor node; and
normalizing the calculated attention coefficient of the central node, and a calculation formula being as follows:

$${α}_{i j} = \frac{exp ( Leaky Re LU ( {e}_{ij} ) )}{\sum k ∈ {N}_{i} exp ( Leaky Re LU ( {e}_{ij} ) )} \qquad ( 3 )$$

where LeakyReLU( ) is a linear activation function, and exp( ) is a normalized function of softmax( ).

### 2.3) Performing Node Feature Aggregation Based on a Multi-Head Attention Mechanism

According to the calculated attention coefficient, performing weighted aggregation on the features of the neighbor nodes to the central node, and a calculation formula being as follows:

$${h}_{i}^{′} = σ ( {\sum }_{j ∈ {N}_{i}} {α}_{i j} W {h}_{j} ) \qquad ( 4 )$$

where W is a linear transformation weight matrix multiplied by the features, αᵢⱼ is the attention correlation coefficient calculated above, σ is a nonlinear activation function, j represents all neighbor nodes adjacent to the central node i, and hⱼ is a feature vector of the neighbor node; and
in order to stably learn the attention coefficient of the central node relative to the neighbor nodes, introducing the multi-head attention mechanism in the process of weighted aggregation, where each independent attention mechanism is capable of learning features in different representation spaces, K independent attention mechanisms executing formula (4), and then averaging the features of the above independent attention mechanisms to obtain a vector representation of the central node,

$${h}_{i}^{′} = σ ( \frac{1}{K} {\sum }_{k - 1}^{K} {\sum }_{j ∈ {N}_{i}} {α}_{i j}^{k} {W}^{k} {h}_{j} ) \qquad ( 5 )$$

where aᵢⱼ^{k} is an attention coefficient obtained by means of normalized calculation of the k^{th} attention mechanism, W^{k} is a linear transformation weight matrix of the k^{th} attention mechanism, j traversed in j∈Nᵢ represents all neighbor nodes adjacent to the central node i, and hⱼ is a feature vector of these neighbor nodes, thereby obtaining a final vector representation of the central node by means of averaging operation and a linear activation function.

### 2.4) Achieving Vector Representation of the Health State Knowledge Graph

By taking a health state node of a component as a central node, and a subordinate index node and a health state node of an adjacent component as neighbor nodes, executing steps 2.2) and 2.3) to obtain a vector representation of the health state node of the component, and then, by taking a health state node of the equipment as a central node and the health state node of the component as a neighbor node, executing steps 2.2) and 2.3) again to obtain a vector representation h′ of the health state node of the equipment.

### 3) Performing Health State Assessment on the Equipment

Converting a health state assessment problem into a classification problem of a target node based on the vector representation, and implementing classification of the target node by using the vector representation h′ obtained in step 2.4), where the target node refers to the health state node of the equipment in the knowledge graph;
inputting the vector representation h′ into a linear classifier to obtain a classification probability \tilde{y}_{ι}, and a calculation formula of \tilde{y}_{ι} being as follows:

$$\tilde{{y}_{i}} = sigmoid ( h ) \qquad ( 6 )$$

where the function sigmoid( ) maps the vector into the range [0, 1], and \tilde{y}_{ι} is a class prediction probability of the equipment;
then, according to the calculated probability \tilde{y}_{ι}, performing loss calculation by means of a loss function and a true label yᵢ in a sample; minimizing the loss function by using a cross-entropy loss function and an Adam optimizer, and a calculation formula of the loss function being as follows:

$$L = - {{\sum }_{i = 1}}^{C} {y}_{i} log \tilde{{y}_{i}} \qquad ( 7 )$$

where C is a classification class, \tilde{y}_{ι} is a class prediction probability, and yᵢ is a true label value;
continuously iterating the above training process to make the vector representation of the health state of the equipment converge, thereby obtaining the final health state assessment model of the equipment; and inputting the health state knowledge graph of the equipment to be evaluated into the above training model to obtain a health state classification result of the equipment, thereby
completing the health state assessment of the equipment by means of all the above steps.

The present invention has the beneficial effects:

According to the health state assessment method for equipment provided by the present invention, temporal domain features and spatial domain features in the health state knowledge graph can be fully learned, and the accuracy of the health state assessment result of the equipment is improved by means of the embedded spatial-temporal feature vectors.

### BRIEF DESCRIPTION OF THE DRAWINGS

FIG. 1 is a health state knowledge graph;

FIG. 2 is a model map of a health state knowledge graph body; and

FIG. 3 is a health state assessment model map based on a knowledge graph attention network.

### DETAILED DESCRIPTION OF THE EMBODIMENTS

The present invention will be further described below with reference to the accompanying drawings.

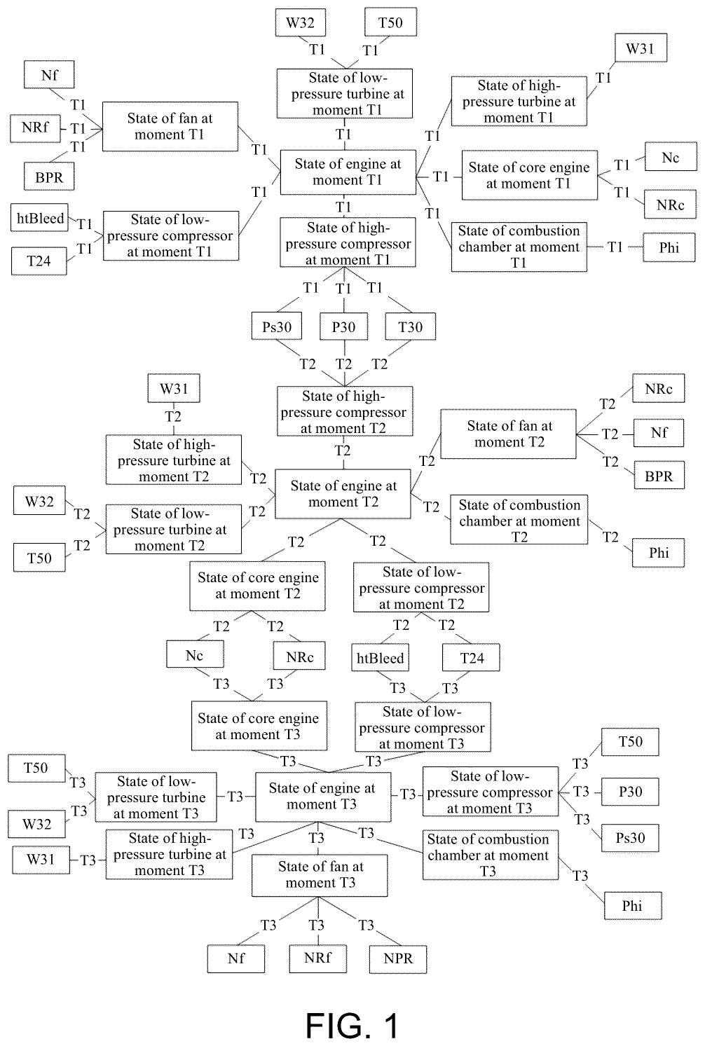

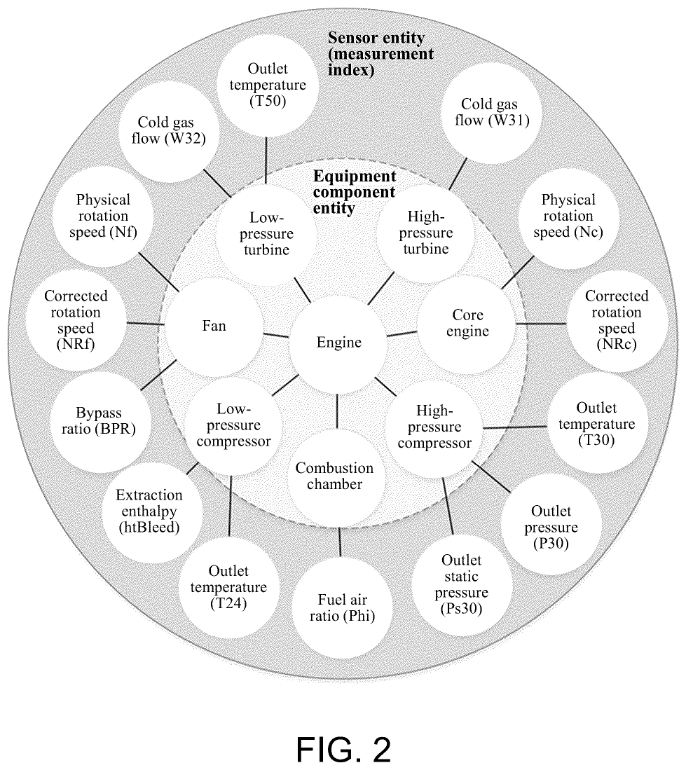

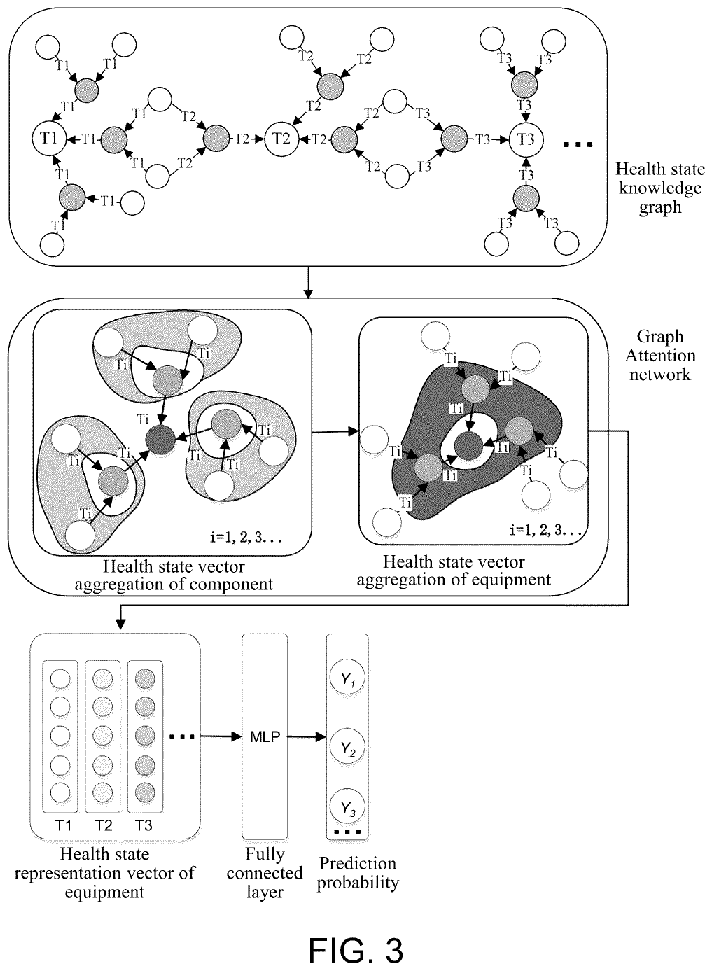

Referring to FIG. 1, FIG. 2 and FIG. 3, a health state assessment method for equipment based on a knowledge graph attention network includes the following steps:

Step (1) construct a health state knowledge graph of the equipment:

Step (1.1) extract component entities and association relationships thereof of an engine according to priori knowledge, where the engine includes seven component entities, namely a core engine, a combustion chamber, a fan, a high-pressure turbine, a low-pressure turbine, a high-pressure compressor and a low-pressure compressor.

Step (1.2) extract a subordinate monitoring data entity of each component entity: firstly, determine indexes related to the health state, and remove noise date; determine a different interval size for each sensor index, and perform interval division operation on the sensor index; since a variance of each sensor index is different, normalize each index by means of formula (1) to eliminate influence of different dimensional data on an experiment; and extract monitoring data entities, for example, the fan component entity has three monitoring data entities, namely a physical rotation speed (Nf), a corrected rotation speed (NRf) and a bypass ratio (BPR).

Step (1.3) construct the health state knowledge graph of the engine according to the entities and relationships thereof extracted in steps (1.1) and (1.2), as shown in FIG. 1. The constructed health state knowledge graph triplet of the engine is shown in Table 1:

TABLE 1
Health state knowledge graph triple of engine

| | Relationship | Tail entity or |
|---|---|---|
| Head entity | or attribute | attribute value |
| Health state of | Fuel air ratio | Phi |
| combustion chamber | | |
| Health state of core engine | Corrected rotation speed | NRc |
| Health state of core engine | Physical rotation speed | Nc |
| Health state of fan | Physical rotation speed | Nf |
| Health state of fan | Corrected rotation speed | NRf |
| Health state of fan | Bypass ratio | BPR |
| Health state of low- | Extraction enthalpy | htBleed |
| pressure compressor | | |
| Health state of low- | Outlet temperature | T24 |
| pressure compressor | | |
| Health state of low- | Cold gas flow | W32 |
| pressure turbine | | |
| Health state of low- | Outlet temperature | T50 |
| pressure turbine | | |
| Health state of high- | Outlet static pressure | Ps30 |
| pressure compressor | | |
| Health state of high- | Outlet pressure | P30 |
| pressure compressor | | |
| Health state of high- | Outlet temperature | T30 |
| pressure compressor | | |
| Health state of high- | Cold gas flow | W31 |
| pressure turbine | | |

An adjacency matrix A corresponding to the health state knowledge graph is established for calculation in subsequent steps. The adjacency matrix reflects a connection relationship between nodes, 1 represents being connected, and 0 represents not being connected. For example, the engine in FIG. 1 is connected to the combustion chamber, the fan, the high-pressure compressor, the high-pressure turbine, the low-pressure compressor, the low-pressure turbine, and the core engine, and (A)_{(engine,combustion chamber})=(A)_{(combustion chamber,engine)}=(A)_{(engine,fan)}=(A)_{(fan,engine)}=(A)_{(engine,high-pressure compressor)}=(A)_{(high-pressure compressor,engine)}=1.

(2) Perform representation learning of the knowledge graph based on the graph attention network:

Perform representation learning on the health state knowledge graph of the engine constructed in step (1), where the structure thereof includes one an input layer, two convolutional layers and one fully connected layer, dimensions of the two convolutional layers are [128, 64] and [64, 4] respectively, and finally map a health state vector of the equipment to one of the four health state classes, which are 3, 2, 1 and 0 respectively from high to low. Extract input node features by using the graph attention network, firstly, calculate an attention coefficient of each central node relative to neighbor nodes by means of formula (2), and normalize the above attention coefficient by means of formula (3) to obtain a final attention coefficient. Finally, weigh and sum up the node features by means of formula (4) according to the obtained attention coefficient, thereby obtaining the vector representation of the central node.

Employ K mutually independent graph attention mechanisms, where the vector representations under different graph attention mechanisms are obtained by referring to formulas (2), (3) and (4) for different attention mechanisms. In order to reduce dimensions of the feature vectors, perform averaging operation on these vector representations by executing formula (5), and pass through a linear activation layer to obtain a health state vector representation of the engine.

Step (3) Perform health state assessment on the equipment:

Firstly, input the health state vector representation of the engine obtained in step (2) into formula (6) to obtain a health state classification probability of the engine.

Secondly, enable a calculated classification result to continuously approach a true label according to a loss between the classification prediction probability calculated in loss function reduction formula (6) of formula (7), such that the health state vector representation of the engine is more accurate.

Perform a continuous iteration training process to enable the health state assessment model of the engine to converge, thereby obtaining a final health state assessment result of the engine.

What is claimed is:

1. A health state assessment method for equipment based on a knowledge graph attention network, comprising:
step 1) constructing a health state knowledge graph of the equipment, comprising:
step 1.1) extracting component entities and relationships;
step 1.2) extracting monitoring index entities and relationships; and
step 1.3) constructing the knowledge graph;
step 2) performing representation learning of the knowledge graph based on the graph attention network, comprising:
step 2.1) achieving input and output of the graph attention network;
step 2.2) calculating an attention coefficient of a central node;
step 2.3) performing node feature aggregation based on a multi-head attention mechanism; and
step 2.4) achieving vector representation of the health state knowledge graph; and
step 3) performing health state assessment on the equipment based on representation learning.

2. The health state assessment method for equipment based on the knowledge graph attention network according to claim 1, wherein the step 1.1) comprises:
separately extracting the component entities and relationships according to a composition relationship between a system and components, wherein each non-divisible component represents a component entity, and the component relationships comprise an energy transfer relationship, a structure composition relationship and a control relationship;
wherein the step 1.2) comprises:
extracting the monitoring index entities and the monitoring relationships with the component entities from time series data, and performing normalization processing;
performing division by using a time sliding window technique for each piece of monitored time series data {xₜ_{₁}, xₜ_{₂}, xₜ_{₃}, . . . , xₜ_{ₙ}}, setting a window size as b, and aggregating a monitored value set of each window, wherein a common aggregation method is to find an average value, that is, if xₜ_{_{y}}∈[xₜ_{₁},xₜ_{₁}+b),
$${x}_{{t}_{y}} = \frac{1}{k} {\sum }_{i = 1}^{k} {x}_{{t}_{i}} \} ;$$
normalizing different monitoring data by a calculation formula (1) being as follows:
$${x}_{norm}^{i} = \frac{{x}^{i} - {x}_{mean}^{i}}{{\partial }^{i}} \qquad ( 1 )$$
wherein xₙₒᵣₘⁱ represents a normalized value of the ith sensor, xⁱ represents data collected by the ith sensor, and xₘₑₐₙⁱ and ∂ⁱ represent a mean value and a variance of an original measurement value of the ith sensor respectively; and
wherein the step 1.3) comprises:
constructing the health state knowledge graph of the equipment according to the extracted component entities, component relationships, monitoring index entities and monitoring relationships, wherein component nodes represent health states of components at a certain moment, and a formal definition is as follows:
the health state knowledge graph of the equipment is a directed graph which is composed of the component entities, the monitoring index entities, the component relationships and the monitoring relationships, has time labels, and is expressed as G=(E, R, T, τ), wherein E is an entity set, which comprises the component entities and the monitoring index entities, R is a relationship set with time stamps, which is used for representing factual relationships comprising the component relationships and the monitoring relationships, τ represents a current time stamp of the knowledge graph, T={(h, r, t)|h, t∈E, r∈R} is a set of triples, and
the constructed health state knowledge graph with the time labels is capable of expressing the relationship between a health state of the equipment at each moment and a monitoring index.

3. The health state assessment method for equipment based on the knowledge graph attention network according to claim 1, wherein the step 2) comprises:
embedding the health state knowledge graph into a unified vector representation space by using a graph attention network model to obtain vector representations of the entities and relationships, and then using a vector representation of a target entity for subsequent health state assessment of the equipment;
wherein the step 2.1) comprises:
defining a node feature of input of the graph attention network as h={h₁, h₂, . . . , h_{N}}, hᵢ∈R^{F}, wherein N is the number of nodes, F is a dimension of the node feature, an output new feature vector is F′ after passing through the graph attention network, and an output feature vector is represented as h={h₁′, h₂′, . . . , h_{N}′}, hᵢ′∈R^{F′};
wherein the step 2.2) comprises:
in order to obtain sufficient expression ability, converting an input feature into a higher-level vector representation, calculating attention coefficients between the central node and neighbor nodes thereof one by one by a calculation formula (2) being as follows:
$${e}_{i j} = a ( [ {W}_{e} {h}_{i} ‖ {W}_{e} {h}_{j} ] ) \qquad ( 2 )$$
wherein Wₑ∈R^{F′×F} is a shared weight matrix, linear transformation of the nodes is expressed as Wₑhᵢ∈R^{F′}, the features after the linear transformation of the nodes are spliced by using the method of ⋅∥⋅, that is, Wₑhᵢ∥Wₑhⱼ∈R^{2F′}, a(⋅) is a single-layer feedforward neural network with a parameter of \vec{a}∈R^{2F′}, and the spliced high-dimensional features to the real number R by using the method of a(⋅), thereby obtaining the attention coefficient of the central node relative to each neighbor node;
normalizing the calculated attention coefficient of the central node by a calculation formula (3) being as follows:
$${α}_{ij} = \frac{exp ( Leaky Re LU ( {e}_{ij} ) )}{\sum k ∈ {N}_{j} exp ( Leaky Re LU ( {e}_{ij} ) )} \qquad ( 3 )$$
wherein LeakyReLU( ) is a linear activation function, and exp( ) is a normalized function of softmax( );
wherein the step 2.3) comprises:
performing weighted aggregation on the features of the neighbor nodes to the central node according to the calculated attention coefficient by a calculation formula (4) being as follows:
$${h}_{i}^{′} = σ ( {\sum }_{j ∈ {N}_{i}} {α}_{i j} W {h}_{j} ) \qquad ( 4 )$$
wherein W is a linear transformation weight matrix multiplied by the features, αᵢⱼ is the calculated attention coefficient, σ is a nonlinear activation function, j represents all neighbor nodes adjacent to the central node i, and hⱼ is a feature vector of the neighbor node;
introducing the multi-head attention mechanism in the process of weighted aggregation, wherein each independent attention mechanism is capable of learning features in different representation spaces, K independent attention mechanisms executing the calculation formula (4), and averaging the features of the above independent attention mechanisms to obtain a vector representation of the central node by a calculation formula (5) being as follows,
$${h}_{i}^{′} = σ ( \frac{1}{K} {\sum }_{k - 1}^{K} {\sum }_{j ∈ {N}_{i}} {α}_{i j}^{k} {W}^{k} {h}_{j} ) \qquad ( 5 )$$
wherein αᵢⱼ^{k} is an attention coefficient obtained by means of normalized calculation of the k^{th} attention mechanism, W^{k} is a linear transformation weight matrix of the k^{th} attention mechanism, j traversed in j∈Nᵢ represents all neighbor nodes adjacent to the central node i, and hⱼ is a feature vector of the neighbor node, thereby obtaining a final vector representation of the central node by means of averaging operation and a linear activation function; and
wherein the step 2.4) comprises:
by taking a health state node of a component as a central node, and a subordinate index node and a health state node of an adjacent component as neighbor nodes, executing the steps 2.2) and 2.3) to obtain a vector representation of the health state node of the component, and then, by taking a health state node of the equipment as a central node and the health state node of the component as a neighbor node, executing the steps 2.2) and 2.3) again to obtain a vector representation h′ of the health state node of the equipment.

4. The health state assessment method for equipment based on the knowledge graph attention network according to claim 1, wherein the step 3) comprises:
converting a health state assessment problem into a classification problem of a target node in the knowledge graph by using a result of knowledge graph representation learning, and implementing classification of the target node by using the vector representation h′ obtained in the step 2.4), wherein the target node refers to the health state node of the equipment in the knowledge graph;
inputting the vector representation h′ into a linear classifier to obtain a classification probability \tilde{y}_{ι} by a calculation formula (6) being as follows:
$$\tilde{{y}_{i}} = sigmoid ( h ) \qquad ( 6 )$$
wherein the function sigmoid( ) maps the vector into the range [0, 1], and \tilde{y}_{ι} is a class prediction probability of the equipment;
performing loss calculation by means of a loss function and a true label yᵢ in a sample according to the calculated probability \tilde{y}_{ι}; minimizing the loss function by using a cross-entropy loss function and an Adam optimizer by a calculation formula (7) of the loss function being as follows:
$$L = - {\sum }_{i = 1}^{C} {y}_{i} log \tilde{{y}_{i}} \qquad ( 7 )$$
wherein C is a classification class, \tilde{y}_{ι} is a class prediction probability, and yᵢ is a true label value;
continuously iterating the above training process to make the vector representation of the health state of the equipment converge, thereby obtaining the final health state assessment model of the equipment; and inputting the health state knowledge graph of the equipment to be evaluated into the above training model to obtain a health state classification result of the equipment, thereby completing the health state assessment of the equipment by means of all the above steps.
